(19) United States
(12) Patent Application Publication
(10) Pub. No.: US 2025/0332679 A1
(43) Pub. Date: Oct. 30, 2025

(54) MIRROR MILLING PROCESSING AND MEASUREMENT PROCESS AND CONTROL PROCESS METHOD, AND SYSTEM THEREOF

(71) Applicant: SHANGHAI TOP NUMERICAL CONTROL TECHNOLOGY CO., LTD., Shanghai (CN)

(72) Inventors: Yuhan WANG, Shanghai (CN); Bin YAO, Shanghai (CN)

(21) Appl. No.: 18/677,416

(22) Filed: May 29, 2024

(30) Foreign Application Priority Data
Apr. 24, 2024 (CN) 202410495726.0

(51) Int. Cl. B23Q 17/20; B23C 3/00; B23Q 15/12

(52) U.S. Cl. CPC B23Q 17/20; B23C 3/00; B23Q 15/12

(57) ABSTRACT

The present invention relates to the technical field of mirror milling, in particular to a mirror milling processing and measurement process and control process method, and system thereof, wherein, the thin-walled part processing path program transplantation procedure comprises: aligning, according to an actual positioning hole in a point cloud data obtained by scanning the thin-walled part and the theoretical positioning hole on a theoretical triangle mesh curved surface generated by a design curved surface, an actual triangle mesh curved surface corresponding to the point cloud data with the theoretical triangle mesh curved surface; calculating, for a plurality of cutter location points in a cutter location file, geodesic information between each of the cutter location points and the theoretical positioning hole respectively; transplanting, according to the geodesic information, the cutter location points to the actual triangular mesh curved surface to form a transplantation processing path.

### BACKGROUND OF THE INVENTION

### 1. Field of the Invention

The present invention relates to the technical field of mirror milling, in particular to a mirror milling processing and measurement process and control process method, and system thereof.

### 2. Description of the Related Art

Mirror milling is a processing method designed for large thin-wall aircraft skin. Compared with traditional milling, the main difference is that in the processing the corresponding support measuring device is applied on the back of the skin, and in the processing the milling tool and the support measuring device are aligned with the skin from both sides, and the milling process is carried out through synchronous motion. It can achieve better product uniformity than the chemical etching milling used in traditional skin processing.

In the existing technology, there are already technical solutions for milling thin-walled part such as aircraft skin.

For example, the Chinese patent No. CN201410532797.X discloses an aircraft skin mirror image milling method and equipment thereof, which is characterized by the equipment mainly includes a main frame of the machine tool, a milling device, a vertical and horizontal conversion device, an ear clamping device, a flexible adsorption device, a jacking device, a testing device and a thickness measuring device. The invention can improve the clamping efficiency by vertically clamping the skin via the vertical and horizontal conversion device, and further improve the positioning accuracy of skin by combining a vacuum adsorption device to avoid deformation caused by gravity. The in-machine detection based on the laser displacement sensor can detect the actual curved surface of the skin parts before processing, and adjust the skin machining tool track according to the actual clamping state, so as to realize the adaptive CNC machining. In the process of skin milling, the jacking device can support the skin parts from the back side, avoid the machining flutter and improve the machining stability. The thickness can be monitored online during processing, and the thickness compensation can be provided. The integrated control system ensures the cooperative operation of each unit of the machine and avoids interference.

For another example, the Chinese patent No. CN201910811713.9 discloses a skin milling processing defect detection device, involving the field of skin processing, aimed at real-time detection and positioning of skin milling processing defects. The device is used for a milling machine. The device comprises a PC end, an infrared camera, a TOF depth camera and a magnetic field motion module. The magnetic field motion module and the milling cutter are connected to the milling machine spindle through the milling chuck, to realize the transmission of milling machine torque. In the skin milling process, the milling machine spindle drives the milling cutter and the magnetic field motion module to rotate, and the skin cuts the magnetic force line of the magnetic field motion module to generate the dynamic eddy current therein. The infrared camera is used to detect the temperature distribution of the skin surface. The TOF depth camera is used to reconstruct the three-dimensional shape of the skin. The PC end is used to obtain and analyze a three-dimensional temperature distribution diagram according to the temperature distribution and the three-dimensional shape to detect the internal defects of the skin.

However, in the actual implementation process, the inventor found that limited by the physical characteristics of the thin-walled part itself, it is easy to produce a certain deformation during the processing, for example, the central area arches or sags, which leads to the curved surface of the thin-walled part itself is not completely consistent with the design curved surface and the design cutter path in the milling process, which affects the processing accuracy.

### SUMMARY OF THE INVENTION

Aiming at the above problems existing in the prior art, a mirror there is provided a mirror milling processing and measurement process and control process method. On the other hand, a processing system for implementing the processing method is also provided.

The technical solution is as follows:
A mirror milling processing and measurement process and control process method, comprising a thin-walled part clamping and transferring procedure, a thin-walled part measurement and point cloud acquisition procedure, a thin-walled part processing path program transplantation procedure, a thin-walled part processing path post-processing procedure, a thin-walled part processing and thickness measurement and control procedure, and a thin-walled part processing contour detection procedure;
wherein the thin-walled part processing path program transplantation procedure comprises:
aligning, according to an actual positioning hole in a point cloud data obtained by scanning the thin-walled part and a theoretical positioning hole on a theoretical triangle mesh curved surface generated by a design curved surface, an actual triangle mesh curved surface corresponding to the point cloud data with the theoretical triangle mesh curved surface;
calculating, for a plurality of cutter location points in a cutter location file, geodesic information between each of the cutter location points and the theoretical positioning hole respectively;
transplanting, according to the geodesic information, the cutter location points to the actual triangular mesh curved surface to form a transplantation processing path.

On the other hand, during the thin-walled part clamping and transferring procedure, a clamping tooling is arranged to clamp the thin-walled part, the clamping tooling comprises a tooling frame, the tooling frame is mouth-shaped, and a plurality of moving posts are distributed in the tooling frame;
a clamping jaw is installed on the tooling frame and the moving posts, and the clamping jaw clamps and fixes the thin-walled part;
a plurality of jacking devices are further distributed in the tooling frame, and the plurality of jacking devices move from a back of the thin-walled part to a front of the thin-walled part so as to support the thin-walled part.

On the other hand, the thin-walled part clamping and transferring procedure comprises:
hoisting the thin-walled part to the tooling frame, and projecting a laser projection to the tooling frame;
locating the thin-walled part in a coverage area of the laser projection;
adjusting, according to the laser projection and a tooling program, the jacking devices and the clamping jaw so as to adjust the thin-walled part to a predetermined processing state;
clamping the thin-walled parts successively, and scanning the thin-walled parts to obtain the point cloud data.

On the other hand, during the thin-walled part measurement and point cloud acquisition procedure, a machine tool drives a line laser to scan the thin-walled part to construct the point cloud data.

On the other hand, the cutter location point extraction procedure for calculating the cutter location file comprises:
extracting the theoretical positioning hole center coordinates of the theoretical positioning holes on the theoretical triangular mesh curved surface respectively, and extracting the cutter location point information of each of the cutter location points from the cutter location file respectively, wherein the cutter location point information comprises a cutter location point coordinate;
projecting, for each of the cutter location points, the cutter location point onto a theoretical mesh surface of the theoretical triangle mesh curved surface respectively, so as to generate a first projection point and a projection length between the first projection point and the cutter location point coordinate;
calculating the area coordinates of the first projection point with respect to a mesh to which the first projection point is located respectively, and calculating, for each of the theoretical positioning hole center coordinates, a length of the geodesic with respect to the area coordinates respectively to function as the geodesic information.

On the other hand, the path transplantation procedure for forming the transplantation processing path comprises:
extracting the actual positioning hole center coordinates of the actual positioning holes from the point cloud data respectively, and projecting the cutter location point onto a second projection point obtained from an actual mesh surface corresponding to the point cloud data;
calculating, for the second projection point, a length of the pre-projected geodesic with respect to the actual positioning hole center coordinates, and processing, according to the geodesic information, the length of the pre-projected geodesic to obtain a geodesic deviation value;
iterating, according to the geodesic deviation value and the preset geodesic deviation range, the second projection point until the geodesic deviation range is satisfied and the second projection point functions as an actual transplantation point;
generating, according to the actual transplantation point, the transplantation processing path.

On the other hand, the thin-walled part processing path post-processing procedure comprises, generating a new transplanted cutter location file according to the transplantation processing path, and performing a simulation verification on the transplanted cutter location file;
during the thin-walled part processing and measurement and control of the thickness procedure, processing the thin-walled part by the transplanted cutter location file.

On the other hand, during the thin-walled part processing and measurement and control of the thickness procedure, jacking a subsidence area of the thin-walled part by the jacking device.

On the other hand, during the thin-walled part processing and measurement and control of the thickness procedure, measuring the thickness of the thin-walled part in real time by an ultrasonic probe to obtain the real-time thickness of the thin-walled part, and the real-time thickness is used for controlling during the mirror milling procedure of the thin-walled part.

On the other hand, the ultrasonic probe is distributed along a circumferential direction with a plurality of eddy current sensors, and during the measurement procedure of the ultrasonic probe the plurality of eddy current sensor sensors are used for generating an eddy current to measure the eddy current spacing between the ultrasonic probe and the thin-walled part;
during the mirror milling procedure, controlling a distance between the ultrasonic probe and the thin-walled part based on the eddy current spacing.

On the other hand, during the measurement procedure of the ultrasonic probe, controlling the ultrasonic probe to direct to the back normal direction of the thin-walled part through the eddy current normal holding process;
the eddy current normal holding process comprises:
obtaining a back distance between a plurality of eddy current sensors and the thin-walled part;
constructing a machine tool coordinate system according to an eddy current distribution generated by the eddy current sensor, and transplanting the back distance in the machine tool coordinate system respectively;
coinciding a distribution center of the eddy current distribution with an origin of the machine tool coordinate system;
calculating a normal vector of the eddy current in the machine tool coordinate system according to the back distance obtained by transplantation;
adjusting the orientation of the ultrasonic probe based on the normal vector of the eddy current so that the normal vector of the eddy current coincides with a normal vector of the back of the thin-walled part.

On the other hand, the ultrasonic probe is a water immersion ultrasonic probe, an outside of a coupling part of the ultrasonic probe is provided with a nozzle, the nozzle is used to output a water flow filling an area between the coupling part and the thin-walled part during the measurement procedure of the ultrasonic probe;
a front stage of the nozzle is provided with a water pressure sensor and a real-time water pressure value is collected, during the mirror milling procedure, the pressure of the water flow is adjusted by comparing the real-time water pressure value with a standard water pressure value, and the thin-walled part is supported by the pressure of the water.

On the other hand, the thin-walled part processing contour detection procedure includes:
scanning the thin-walled part after processing to obtain a post-processing point cloud data, generating a post-processing scanning curved surface according to the post-processing point cloud data;
identifying a feature region in the design curved surface to obtain a boundary of the feature region;
projecting the boundary of the feature region onto the post-processing scanning curved surface, and performing the geodesic check on a first feature point in the boundary of the feature region and a second feature point of the post-processing scanning curved surface.

A processing system used to implement the mirror milling processing and measurement process and control process method as described above.

On the other hand, the processing system includes a clamping tooling for clamping thin-walled part;
the clamping tooling is provided with a jacking device, the jacking device is used to move synchronously with the milling cutter during the mirror milling procedure, to jack up the thin-walled part;
an ultrasonic probe is arranged on the top of the jacking device, the ultrasonic probe is used for measuring a thickness from the back of the thin-walled part during the mirror milling procedure;
the ultrasonic probe is provided with an eddy current sensor in a circumferential direction, and the processing system, according to the eddy current sensor, controls the ultrasonic probe to maintain a constant normal direction and spacing with respect to the thin-walled part;
an outside of a coupling part of the ultrasonic probe is provided with a nozzle, the nozzle is used to output a water flow filling an area between the coupling part and the thin-walled part during the measurement procedure of the ultrasonic probe;
a front stage of the nozzle is provided with a water pressure sensor and a real-time water pressure value is collected, during the mirror milling procedure, the pressure of the water flow is adjusted by comparing the real-time water pressure value with a standard water pressure value.

The above technical solution has the benefits as follows:
In order to solve the problem that the skin processing method in the prior art is easy to affect the machining accuracy because of the deformation of the skin itself in the actual processing process, in this invention, the point cloud data is obtained by laser scanning measurement after clamping the thin-walled part, and a positioning hole is added in the preprocessing and design process of the thin-walled part at the same time. On this basis, the geodesic information between the cutter location points and the theoretical positioning holes on the design curved surface is obtained by projecting the cutter location points onto the design curved surface. In the future, the corresponding cutter location points can be accurately mapped to the actual processing curved surface of the point cloud data according to the geodesic information, to form a transplantation processing path, which reduces the influence of skin deformation on the tool path and improves the accuracy of machining.

### BRIEF DESCRIPTION OF THE DRAWINGS

Refer to the accompanying drawings to more fully describe embodiments of the present invention. However, the attached drawings are for illustration and elaboration only and do not constitute a limitation on the scope of the invention.

FIG. 1 is an overall schematic diagram of the embodiment of the present invention;

FIG. 2 is a schematic diagram of the thin-walled part processing path program transplantation procedure in the embodiment of the present invention;

FIG. 3 is a simplified diagram of the mirror milling system in the embodiment of the present invention;

FIG. 4 is a schematic diagram of clamping tooling in the embodiment of the present invention;

FIG. 5 is a schematic diagram of the point cloud acquisition process in the embodiment of the present invention;

FIG. 6 is a schematic diagram of the cutter location point extraction procedure in the embodiment of the present invention;

FIG. 7 is a schematic diagram of the geodesic calculation procedure in the embodiment of the present invention;

FIG. 8 is a schematic diagram of the path transplantation procedure in the embodiment of the present invention;

FIG. 9 is a schematic diagram of the eddy current normal holding procedure in the embodiment of the present invention;

FIG. 10 is a nozzle schematic diagram in the embodiment of the present invention;

FIG. 11 is a schematic diagram of the water supply system in the embodiment of the present invention;

FIG. 12 is a schematic diagram of the thin-walled part processing contour detection procedure in the embodiment of the present invention;

FIG. 13 is a schematic diagram of the processing system in the embodiment of the present invention.

### DETAILED DESCRIPTION

The technical solutions in the embodiments of the present invention will be clearly and completely described below in conjunction with the accompanying drawings in the embodiments of the present invention, and it is clear that the described embodiments are only some embodiments of the present invention, not all embodiments. Based on the embodiments in the present invention, all other embodiments obtained by a person skilled in the art without creative labor fall within the scope of protection of the present invention.

It should be noted that, without conflict, the embodiments of the present invention and the features in the embodiments can be combined with each other.

The present invention is further described below in conjunction with the accompanying drawings and specific embodiments, but is not used as a limitation of the present invention.

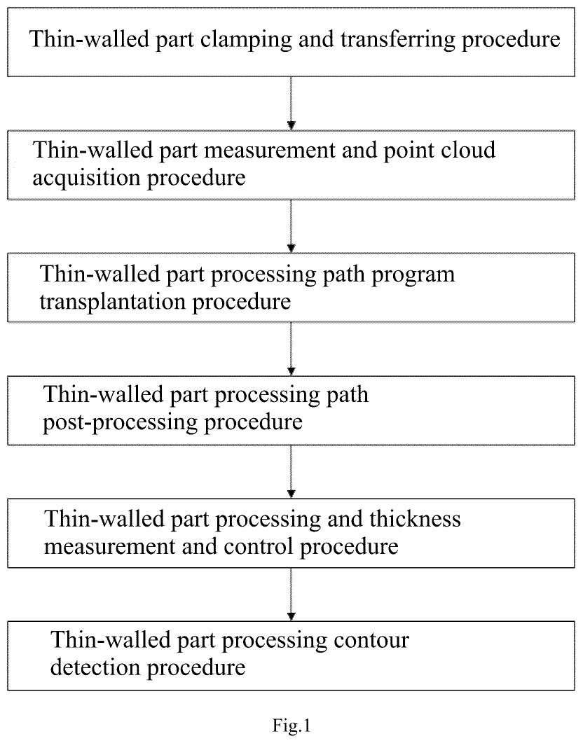

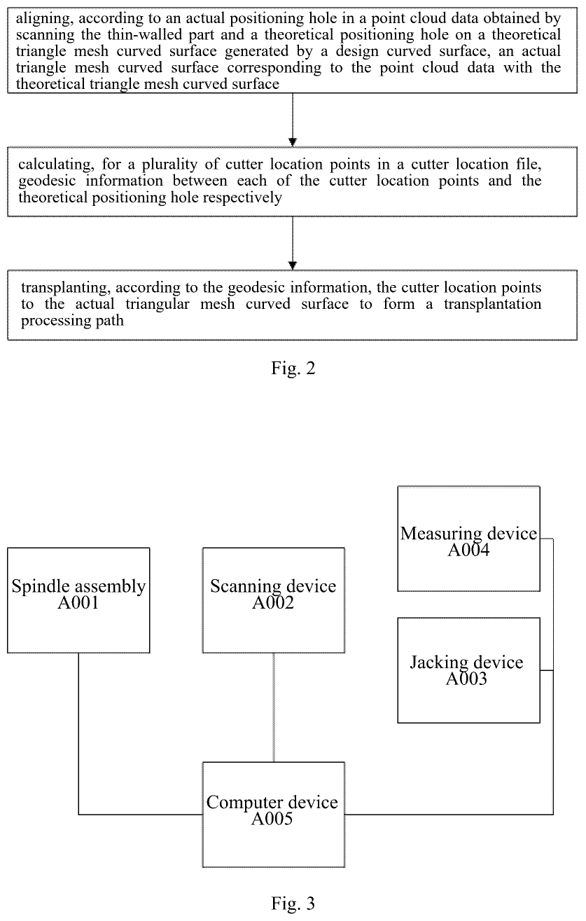

The invention comprises:
Referring to FIG. 1, a mirror milling processing and measurement process and control process method, comprising a thin-walled part clamping and transferring procedure, a thin-walled part measurement and point cloud acquisition procedure, a thin-walled part processing path program transplantation procedure, a thin-walled part processing path post-processing procedure, a thin-walled part processing and thickness measurement and control procedure, and a thin-walled part processing contour detection procedure which are implemented in sequence.
Referring to FIG. 2, the thin-walled part processing path program transplantation procedure comprises:
aligning, according to an actual positioning hole in a point cloud data obtained by scanning the thin-walled part and a theoretical positioning hole on a theoretical triangle mesh curved surface generated by a design curved surface, an actual triangle mesh curved surface corresponding to the point cloud data with the theoretical triangle mesh curved surface;
calculating, for a plurality of cutter location points in a cutter location file, geodesic information between each of the cutter location points and the theoretical positioning hole respectively;
transplanting, according to the geodesic information, the cutter location points to the actual triangular mesh curved surface to form a transplantation processing path.

Specifically, aiming at the problem that the mirror milling processing method in the prior art is easy to affect the machining accuracy due to the deformation of the thin-walled part itself in the actual processing, in this embodiment, the tool path transplantation procedure of the thin-walled part is improved. Wherein, a plurality of positioning holes are set up on the thin-walled part in advance through turning holes or other equivalent processes, and corresponding positioning holes also exist on the design curved surface in the design program of the thin-walled part. Herein, in order to distinguish, the positioning hole on the design curved surface is referred to a theoretical positioning hole, and the positioning hole that actually exists on the thin-walled part is referred to the actual positioning hole, and it is one-to-one correspondence. Normally, the positioning holes are located at the four corners of the periphery of the machining body of the thin-walled part and the number thereof is four, but the number and position may change depending on the type of thin-walled part.

Then, before the tool path is transplanted, a plurality of cutter location points can be extracted for the cutter location file obtained after the tool path design, and the cutter location points correspond to the cutter locations where the thin-walled part is milled to be consistent with the design curved surface during the processing. In order to achieve a more accurate cutter location transplantation procedure, the positioning hole on the design curved surface is taken as a reference in advance, and the geodesic information between each cutter location point and the positioning hole is calculated, and then the cutter location points can also be mapped with respect to the position of the actual positioning hole on the measured point cloud data according to the geodesic information, so as to achieve a more accurate transplantation procedure.

Among them, point cloud data refers to the data obtained by scanning after clamping the thin-walled part. Because the thin-walled part itself has a certain degree of flexibility, it needs to be clamped in advance and jacked to a predetermined processing state, and the entire curved surface of the thin-walled part is scanned by the corresponding scanning equipment, such as a line laser scanner, and the returned laser point cloud is collected and used as point cloud data. The point cloud data includes the position information of each point on the thin-walled part in three-dimensional space, and it is easy to extract the holes on the thin-walled part through further analysis of the point cloud, such as the actual positioning hole.

Based on the above-mentioned transplantation procedure, the cutter location points in the cutter location file can be transplanted to the actual curved surface of the thin-walled part one by one, and the cutter location information, such as the cutter location normal, sequence, the number of rows and other information, can be further combined to process, so as to obtain the corresponding transplantation processing path in series. Based on the transplantation processing path, in the subsequent mirror milling procedure, the processing of the milling cutter and the movement of the jacking device and the measuring device are controlled according to the corresponding mirror milling workflow, so as to achieve better processing effect.

In the actual implementation process, the above-mentioned processing method mainly relies on a specific mirror milling system to realize, and the mirror milling system comprises a corresponding multi-axis processing center, a jacking device that matches the milling cutter and can move synchronously, and a measuring device, and so on. FIG. 3 shows a typical mirror milling system, which comprises a spindle assembly A001 for milling a thin-walled part, a scanning device A002 for curved surface acquisition of a thin-walled part, a jacking device A003, a measuring device A004 and a computer device A005. The computer device A005 may be the control system of the machine tool or other equivalent device, wherein a specific computer program is set up to realize the corresponding function, in particular the above-mentioned processing method.

In order to achieve a better measurement effect, the measuring device can be arranged at the end of the jacking device and synchronize with the movement of the jacking device. For example, the measuring device is an ultrasonic probe, which is located at the end of the jacking device and measures the real-time thickness of the thin-walled part from the back when the jacking device jacks up the thin-walled part, so as to cooperate with the milling cutter on the front side to accurately judge the current situation of the thin-walled part being milled and whether the thickness meets the actual processing requirements.

Before the actual start of the measurement, the corresponding pretreatment process should have been carried out in advance around the thin-walled part, including heat treatment, cold rolling, drawing, roughing or other equivalent processing of the material, so that the thin-walled part can be milled and formed.

In addition, before the actual start of processing, the corresponding design work should also be carried out for the thin-walled part, including the use of three-dimensional design software to design the desired curved surface of the thin-walled part, such as the skin surface, so as to obtain the design curved surface. The design curved surface is actually embodied as a computer program model file, which can be read and displayed by specific 3D industrial design software, and the corresponding processing drawings can be exported according to the requirements.

The cutter location file is a feasible processing scheme to be designed according to the processing parameters of the mirror milling system after determining the raw material parameters and design curved surface of the thin-walled part, including the cutter location points where the thin-walled part needs to be milled to be consistent with the design curved surface, the trajectory composed of the cutter location points and the corresponding cutter location information, such as the cutter location normal direction, the number of rows to which the cutter location locates, the spindle speed, etc. A cutter location file is a file in a specific format, such as a CLS/APT file, which itself can be read and executed by a CNC device to process a workpiece. However, in the scene targeted by the present invention, the cutter location file directly generated usually causes a certain offset in the three-dimensional space between the actual cutter location point of the processing and the expected cutter location of the design due to factors such as the clamping accuracy of the thin-walled part, the material deformation, etc., so the procedure of remapping the cutter location to the actual processing curved surface is involved in the present invention. After this procedure is completed, a corrected cutter location file can be generated, which can then be used for a more accurate milling process.

It should be noted that the transplantation procedure of the tool position should be carried out after the first clamping and scanning of the thin-walled part, and directly used to mill the thin-walled part after the transplantation is completed, so as to avoid the introduction of new offsets in the repeated clamping procedure of the thin-walled part.

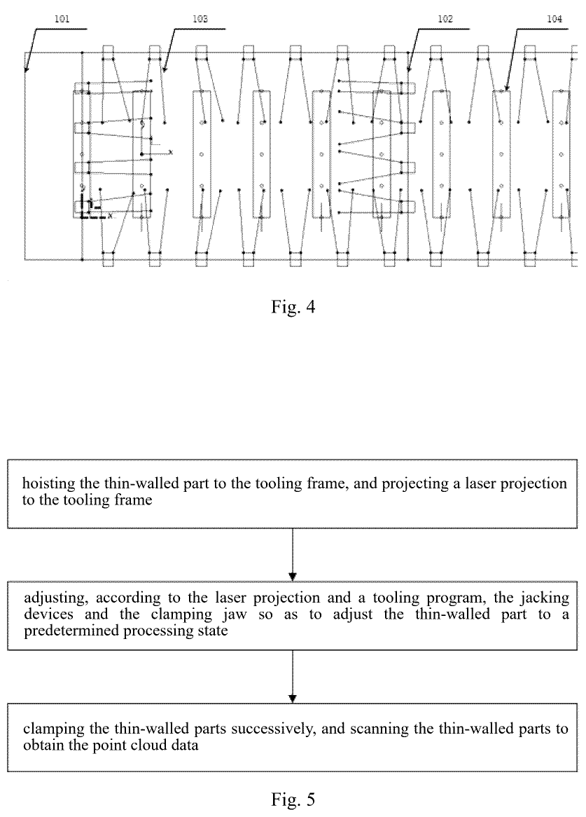

In an embodiment, during the clamping procedure, as referred to FIG. 4, a clamping tooling is arranged to clamp the thin-walled part, the clamping tooling comprises a tooling frame 101, the tooling frame 101 is mouth-shaped, and a plurality of moving posts 102 are distributed in the tooling frame 101;
a clamping jaw 103 is installed on the tooling frame 101 and the moving posts 102, and the clamping jaw 103 clamps and fixes the thin-walled part;
a plurality of jacking devices 104 are further distributed in the tooling frame 101, and the plurality of jacking devices 104 move from a back of the thin-walled part to a front of the thin-walled part so as to support the thin-walled part.

Specifically, in order to achieve a better fixing effect, in this embodiment, the thin-walled part is clamped in advance through the clamping tooling before scanning the thin-walled part. The clamping tooling comprises a mouth-shaped tooling frame 101, and the tooling frame 101 is a hollow frame structure and has a front side and a back side. When the thin-walled part needs to be clamped, the tooling frame 101 is placed facing upwards from the front, and the moving post 102 and the jacking device 104 are arranged on one side close to the back of the tooling frame 101 at this moment. A plurality of clamping jaws 103 are distributed along the circumferential direction on the tooling frame 101 and are used for clamping and fixing the circumferential direction of the thin-walled part.

Because the thin-walled part itself may be a special-shaped structure with an edge that is upturned in three-dimensional space, an additional clamping jaw 103 is also arranged in the tooling frame 101 by moving post 102. The tooling frame 101 is provided with a plurality of guide rails on one side close to the back, and the moving post 102 is movably arranged on the tooling frame 101 through the guide rail, and its position is adjusted as needed, so that the clamping jaw 103 can effectively clamp the edge of the upturned part.

In addition, in order to realize the shape preservation of the thin-walled part, a plurality of jacking devices 104 are also distributed in the tooling frame 101, and the jacking devices 104 are used for jacking up the back of the thin-walled part according to the jacking program, so as to maintain the thin-walled part in a specific bending state, so as to facilitate subsequent scanning, measurement, milling and other operations.

In order to achieve a better jacking effect, in case the tooling frame 101 is rectangular, a plurality of jacking devices 104 can be distributed in a rectangular shape in the tooling frame 101 and the jacking height can be controlled respectively, to realize the support and shape preservation of thin-walled part.

Similarly, the number of the above-mentioned clamping jaws 103 and the moving posts 102 can also be disassembled, installed, position adjusted and angle adjusted according to the shape, size and other parameters of the thin-walled parts that are actually processed.

In an embodiment, as referred to FIG. 5, the thin-walled part clamping and transferring procedure comprises:
hoisting the thin-walled part to the tooling frame, and projecting a laser projection to the tooling frame;
locating the thin-walled part in a coverage area of the laser projection;
adjusting, according to the laser projection and a tooling program, the jacking devices and the clamping jaw so as to adjust the thin-walled part to a predetermined processing state;
clamping the thin-walled parts successively, and scanning the thin-walled parts to obtain the point cloud data.

Specifically, around the clamping tooling, the workflow can be used to clamp and scan to obtain more accurate point cloud data.

Specifically, before hoisting the thin-walled part, the corresponding jacking program is compiled around the design curved surface in advance, including the jacking parameters through which the thin-walled part is jacked to a predetermined processing state, and the number of jacking devices actually on the tooling frame is matrixed to generate matrix point graphs, and then the corresponding tooling program is generated for controlling the jacking devices.

In addition, laser projection assistance is also introduced in the clamping procedure around the thin-walled parts, so as to achieve a better clamping indication procedure. The laser projection assistance is realized by a laser projector, which is used to project a laser pattern on the surface of the object to indicate various positions in the clamping procedure, including the position where the edge of the thin-walled part locates, the clamping position where the clamping jaw clamps the thin-walled part, and so on.

In order to realize this procedure, it is also necessary to carry out the laser projection programming procedure in advance, specifically including planning the front of the tooling frame, determining the positioning mark on which the laser projection depends in the projection procedure, such as the positioning identification of the tooling frame, the position of the actual positioning hole of the thin-walled part, and so on. On the basis of determining the relative reference object, the corresponding clamping line is further planned, and the laser projection programming is carried out through the projector, which is converted into the corresponding laser projection programming file for subsequent invoking.

After completing the preparatory procedure, the thin-walled part can be hoisted. Specifically, this involves placing the tooling frame horizontally, and then lifting the thin-walled part above the tooling frame and dropping it. In this procedure, the height of the jacking device is adjusted in advance through the tooling program, and the laser projector is controlled for projection based on the laser projection programming file after the thin-walled part has fallen. Specifically, the central mark of the laser projection is aligned with the target point on the surface of the thin-walled part or the surface of the tooling frame, then the actual positioning hole of the thin-walled part is projected, and the direction of the thin-walled part and the height of the jacking device are fine-tuned according to the projection position, until the actual positioning hole coincides with the positioning hole mark of the projection, indicating that the thin-walled part has reached a predetermined processing state, and clamping can be carried out. The clamping jaws should be clamped sequentially in accordance with the corresponding construction specifications in the clamping procedure, so as to avoid exerting additional stress on the thin-walled part.

Finally, when the thin-walled parts are clamped, they are transferred to the thin-walled part measurement and point cloud acquisition procedure, and the point cloud data is obtained by scanning. In one of the embodiments, a line laser is employed as a means of scanning. Specifically, around the design curved surface, a line laser scanning program that can perform a complete scan of the design curved surface is built in advance in the same coordinate system of the design curved surface. Subsequently, the machine tool drives the line laser to scan the entire frontal surface of the thin-walled part, and the reflected signal is collected as the scan data. Based on the scan data, it is reconstructed together with the kinematic algorithm of the machine tool, it is easy to process the spatial point cloud data corresponding to the curved surface of the thin-walled part as the point cloud data to output.

In an embodiment, during the thin-walled part processing and measurement and control of the thickness procedure, jacking a subsidence area of the thin-walled part by the jacking device.

Specifically, after selecting the clamping tooling for clamping, in order to achieve better milling accuracy, after scanning the thin-walled part, the tooling frame at the time of scanning can be directly flipped and transferred to the processing position for the subsequent milling procedure. At this time, the jacking device is connected to the mirror milling system, and is controlled to synchronize with the milling cutter on the front during the processing, so as to carry out the jacking of the subsidence area of the thin-walled part during the processing, so as to achieve a better processing effect.

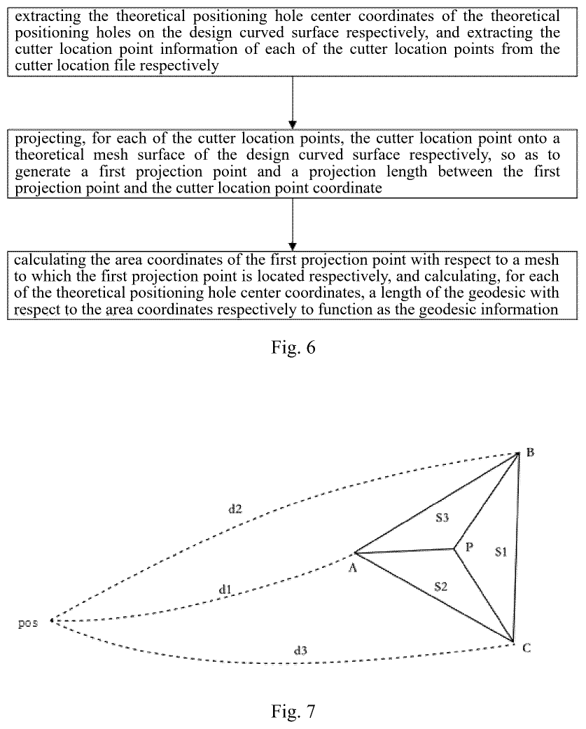

In an embodiment, as referred to FIG. 6, the cutter location point extraction procedure for calculating the cutter location file comprises:
extracting the theoretical positioning hole center coordinates of the theoretical positioning holes on the theoretical triangular mesh curved surface respectively, and extracting the cutter location point information of each of the cutter location points from the cutter location file respectively, wherein the cutter location point information comprises a cutter location point coordinate;
projecting, for each of the cutter location points, the cutter location point onto a theoretical mesh surface of the theoretical triangle mesh curved surface respectively, so as to generate a first projection point and a projection length between the first projection point and the cutter location point coordinate;
calculating the area coordinates of the first projection point with respect to a mesh to which the first projection point is located respectively, and calculating, for each of the theoretical positioning hole center coordinates, a length of the geodesic with respect to the area coordinates respectively to function as the geodesic information.

Specifically, after obtaining the design curved surface and cutter location file, the geodesic information of each cutter location point with respect to the coordinates of the theoretical positioning hole can be obtained through the above workflow, which can be used as a reference for subsequent cutter location point transplantation.

Among them, for the design curved surface, the design curved surface point cloud can be formed through equal spacing discretization processing in advance, and then the point cloud data similar to the point cloud data can be constructed. The spacing can be set according to the scanning interval of the line laser. The procedure of discretization processing includes, obtaining the parameter range of the design curved surface, and after parameterizing the curved surface, changing the value of U-V on the U-V plane according to the spacing, a plurality of points can be obtained and added to the point cloud of the design curved surface. Subsequently, the central coordinates of the theoretical positioning holes on the design curved surface can be easily extracted by combining the predetermined positions of the theoretical positioning holes in the design curved surface, and the center coordinates of the theoretical positioning holes after point cloudification can be extracted by combining with the point clouds of the design surface. Through this processing, the center coordinates of the theoretical positioning hole can be adjusted to the coordinates consistent with the point cloud data, which is convenient for subsequent alignment with the actual positioning hole in the point cloud data.

For the tool position file, a plurality of cutter location points can be obtained by reading the cutter location file in a loop, and the information of the cutter location points mainly includes the cutter location point coordinates, normal direction and the number of lines where the cutter location points are located. In the procedure of transplantation, the main concern is the spatial change of the deformation of the thin-walled parts to the position of the mapped cutter location points, that is, the migration of the coordinates of the cutter location points.

In order to achieve better processing efficiency, in this embodiment, the design curved surface point cloud of the design curved surface and the point cloud data obtained by scanning are respectively meshed. In one embodiment, the design curved surface and the point cloud data are meshed by the Delaunay triangular meshing algorithm, and the meshed curved surface after the design curved surface is meshed is referred to the theoretical mesh surface, and the meshed curved surface after the point cloud data is meshed is referred to the actual mesh surface.

For the theoretical mesh surface, the cutter location point is projected along the curved surface normal to the theoretical mesh surface, which will inevitably fall in a triangular mesh on the theoretical mesh surface. At this point, the length of the projection between the projection point and the cutter location point, as well as the triangular mesh where the projection point is located, are recorded as the projection point mesh. Inside the projection point mesh, the projection points being connected to the vertices of the projection point mesh respectively will result in a plurality of mesh sub-units inside the projection point mesh. In the triangular mesh, the number of mesh sub-units is three. The area coordinates are calculated for the mesh sub-units, then the geodesic length of the projection point with respect to one of the theoretical positioning holes can be interpolated by the geodesic length and area coordinates from the positioning hole coordinates to the three vertices, and finally the geodesic length of the projection points with respect to each theoretical positioning hole is summarized, that is, the complete geodesic information is obtained, which is convenient for the subsequent transplantation of cutter location points.

Specifically, referring to FIG. 7, in a triangular mesh with three vertices A, B, and C, three mesh sub-units are arranged, the center position of which is the projection point p, and the area coordinates of the mesh sub-units are S1, S2, and S3 respectively, and S1+S2+S3=1 are satisfied, then the length of the geodesic line between the external theoretical positioning hole “pos” and the projection point is d=d1*S1+d2*S2+d3*S3.

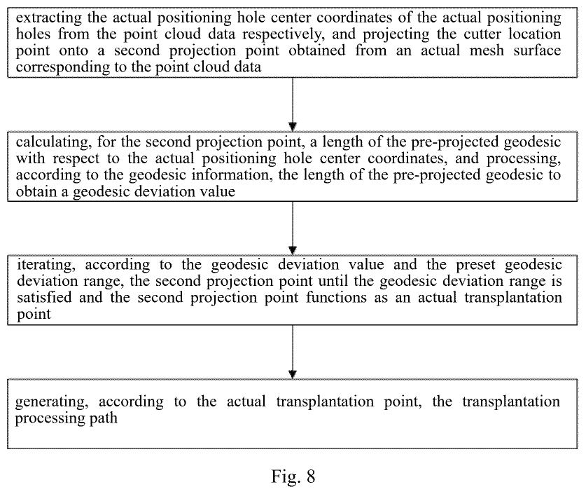

In an embodiment, as referred to FIG. 8, the path transplantation procedure for forming the transplantation processing path comprises:
extracting the actual positioning hole center coordinates of the actual positioning holes from the point cloud data respectively, and projecting the cutter location point onto a second projection point obtained from an actual mesh surface corresponding to the point cloud data;
calculating, for the second projection point, a length of the pre-projected geodesic with respect to the actual positioning hole center coordinates, and processing, according to the geodesic information, the length of the pre-projected geodesic to obtain a geodesic deviation value;
iterating, according to the geodesic deviation value and the preset geodesic deviation range, the second projection point until the geodesic deviation range is satisfied and the second projection point functions as an actual transplantation point;
generating, according to the actual transplantation point, the transplantation processing path.

Specifically, after determining the geodesic information described above, the cutter location points can be migrated to the point cloud data based on the geodesic information.

For the point cloud data, the point cloud data associated with the actual positioning hole is extracted because it has been scanned by the line laser in advance. At this time, the point cloud can be identified by the boundary recognition algorithm, the edge part in the point cloud data is obtained, and the hole part in the edge is obtained by combining the curvature recognition, and the center coordinate of the actual positioning hole can be obtained by fitting according to the part of the point cloud data.

Following the mesh processing described above, the actual mesh surface is obtained in advance. For the actual mesh surface, the cutter location point is first projected along the curved surface normal to the actual mesh surface, which will inevitably fall in a triangular mesh on the actual mesh surface.

At this point, the length of the projection between the pre-projected point and the cutter location point, as well as the triangular mesh where the pre-projected point is located, are recorded as the projection mesh. Inside the projection mesh, the pre-projected points connect to the vertices of the projected mesh respectively, which results in a plurality of mesh sub-units inside the pre-projected point mesh. In the triangular projection mesh, the number of the mesh subunits is three, and the area coordinates are calculated for the mesh subunits, and the geodesic length from the cutter location points to the pre-projection point can be interpolated by the geodesic length and area coordinates from the cutter location point to the three vertices, and finally the pre-projected geodesic length is comprehensively obtained by combining the position information of the pre-projected point mesh and the relative position relationship between it and the actual positioning hole.

Based on the length of the pre-projected geodesic, it can be compared with the geodesic information collected in advance, so as to judge whether the position of the pre-projected point that is currently pre-projected with respect to the actual positioning hole conforms to the expectation of the projection, that is, whether the difference between the length of the pre-projected geodesic and the geodesic information is in the geodesic deviation range, if not, the position of the pre-projection point is offset by the optimization algorithm until it enters the geodesic deviation range, and it is taken as the actual projection point.

According to the normal direction of the surrounding mesh points, which is associated with the actual transplantation point, on the actual mesh surface, the normal direction of the actual transplantation point on the actual mesh surface is calculated by using the interpolation fitting method, and then the actual transplantation point on the actual mesh surface is offset by its corresponding projection length along its normal direction, and the actual transplantation point position after actual transplantation can be obtained. Based on the processing of the actual transplantation point and the adjusted normal direction, the transplantation machining trajectory can be obtained for the subsequent mirror milling procedure.

In an embodiment, during the thin-walled part processing and measurement and control of the thickness procedure, measuring the thickness of the thin-walled part in real time by an ultrasonic probe to obtain the real-time thickness of the thin-walled part, and the real-time thickness is used for controlling during the mirror milling procedure of the thin-walled part.

Specifically, in order to achieve a more accurate milling procedure, in this embodiment, in the process of mirror milling, an ultrasonic probe is also used to measure the thickness of the thin-walled part in real time to obtain the real-time thickness of the thin-walled part, which is used to provide closed-loop control of the mirror milling system. Specifically, in order to achieve better processing results, the mirror milling system will arrange a jacking device on the back of the thin-walled part to realize the support and shape preservation of the thin-walled part during the processing, and the jacking device will move synchronously with the milling cutter during the movement of the milling cutter. Optionally, in this system, the ultrasonic probe can be placed at the top of the jacking device to achieve a more accurate thickness measurement process for the cutting part of the milling cutter. During the measurement, the couplant can be adjusted according to the measurement requirements, and in one embodiment, the couplant is a stream of water injected between the ultrasonic probe and the thin-walled part through a nozzle.

In an embodiment, the ultrasonic probe is distributed along a circumferential direction with a plurality of eddy current sensors, and during the measurement procedure of the ultrasonic probe the plurality of eddy current sensor sensors are used for generating an eddy current to measure the eddy current spacing between the ultrasonic probe and the thin-walled part;
during the mirror milling procedure, controlling a distance between the ultrasonic probe and the thin-walled part based on the eddy current spacing.

Specifically, in order to achieve better measurement results, the spacing between the transducer array and the thin-walled part needs to be controlled for the ultrasound probe so that the spacing is filled with couplant, but the couplant is not too thick to effect the accuracy of the measurement.

In this embodiment, the ultrasonic probe is modified, a plurality of eddy current sensors are arranged in the circumferential direction of the ultrasonic probe, which can generate the corresponding eddy current in the direction of the ultrasonic probe and collect the echo signal, based on the intensity of the echo signal combined with the pre-calibrated reflection intensity-distance control function, it is easy to calculate the eddy current spacing of the ultrasonic probe with respect to the thin-walled part, and is used as the machine tool control parameter of the mirror milling system to realize the closed-loop control of the cutting process of the milling cutter.

As an optional embodiment, the number of eddy current sensors is four, evenly spaced at 12, 3, 6, and 9 o'clock of the ultrasonic probe.

In addition, in order to achieve the spacing control procedure described above, the relationship between the strength of the eddy current and the spacing needs to be calibrated before processing, and the calibration procedure comprises:
a metal calibration block is introduced in advance, and the normal direction of the eddy current sensor is subsequently aligned to the surface of the metal calibration block and a certain spacing is maintained, which acts as a zero clearance. At this point, the eddy current value is read and is associated with the zero position for saving. On this basis, the eddy current sensor is moved along the normal direction according to a specific step size to increase the spacing, and the eddy current value is recorded for storage. Linear fitting of each distance and eddy current values collected above, it is easy to obtain the reflection intensity-distance control function.

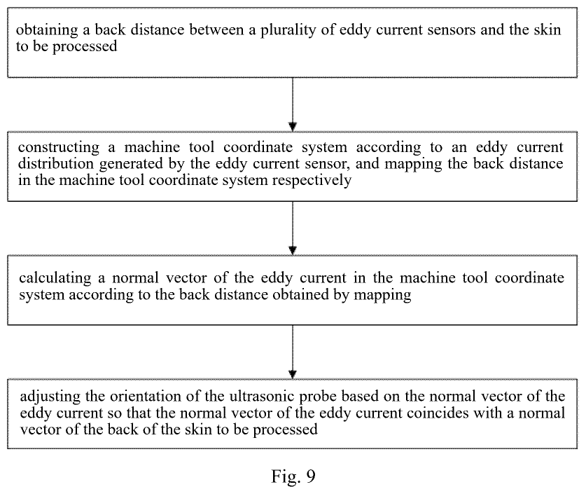

In an embodiment, during the measurement procedure of the ultrasonic probe, controlling the ultrasonic probe to direct to the back normal direction of the thin-walled part through the eddy current normal holding procedure;
as referred to FIG. 9, the eddy current normal holding procedure comprises:
obtaining a back distance between a plurality of eddy current sensors and the thin-walled part;
constructing a machine tool coordinate system according to an eddy current distribution generated by the eddy current sensor, and transplanting the back distance in the machine tool coordinate system respectively;
coinciding a distribution center of the eddy current distribution with an origin of the machine tool coordinate system;
calculating a normal vector of the eddy current in the machine tool coordinate system according to the back distance obtained by transplantation;
adjusting the orientation of the ultrasonic probe based on the normal vector of the eddy current so that the normal vector of the eddy current coincides with a normal vector of the back of the thin-walled part.

Specifically, in order to achieve a better measurement effect, in this embodiment, the ultrasonic probe can be kept consistent with the normal direction of the back of the thin-walled part through the feedback signal of the eddy current sensor. In this embodiment, the ultrasonic probe and the eddy current sensor are mounted on a spherical joint and can freely change its direction.

After the real-time thickness has been measured by eddy current, the back distance of the plurality of eddy current sensors relative to the thin-walled part can be obtained according to this workflow. Then, three of the eddy current sensors are selected, and a machine tool coordinate system is established according to the distribution plane of the eddy currents generated by them, and the machine tool coordinate system takes the distribution centers of the three eddy currents as the coordinate system origin, and the measurement distances of the three eddy current sensors are mapped to the machine tool coordinate system.

The eddy current normal vector between the three eddy currents is calculated, and its values are: n=n1×n2.

Where n1 represents the vector of the first eddy current and the second eddy current, and the direction is from the second eddy current to the first eddy current; n2 represents the vector of the first eddy current and the third eddy current, the direction is from the third eddy current to the first eddy current, n represents the eddy current normal vector of the first eddy current, and the direction is the cross product direction of vector n1 and vector n2, and the calculation process follows the right-hand rule.

Based on the above-mentioned process, the eddy current normal vector can be obtained, and the back side of the thin-walled part has a predetermined theoretical normal vector (0,0,1) in the machine tool coordinate system, and for these two vectors, it is easy to calculate the vector angle between them, which corresponds to the deviation angle of the ultrasonic probe. Then, the rotation of the spherical joint is controlled based on the deviation angle, so that the two vectors coincide, that is, the normal control procedure of the ultrasound probe is completed.

In an embodiment, the ultrasonic probe is a water immersion ultrasonic probe, an outside of a coupling part of the ultrasonic probe is provided with a nozzle, the nozzle is used to output a water flow filling an area between the coupling part and the thin-walled part during the measurement procedure of the ultrasonic probe;
a front stage of the nozzle is provided with a water pressure sensor and a real-time water pressure value is collected, during the mirror milling procedure, the pressure of the water flow is adjusted by comparing the real-time water pressure value with a standard water pressure value.

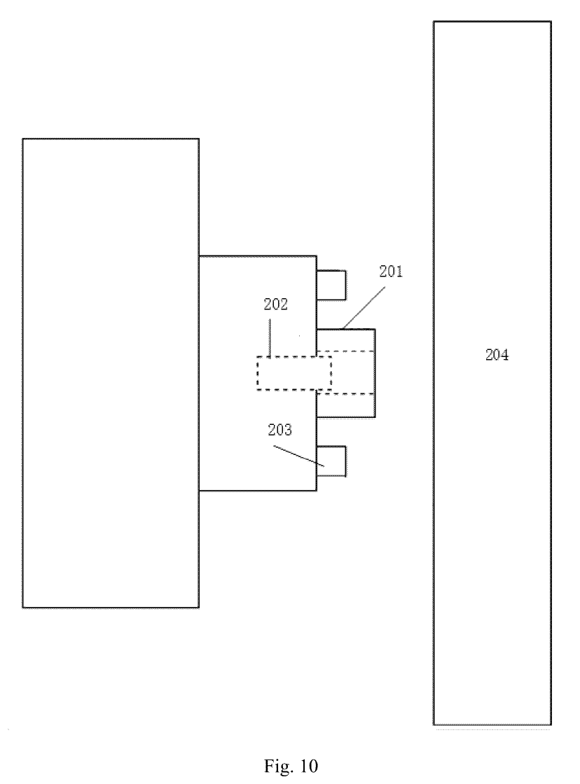

Specifically, in order to achieve a better measurement effect, in this embodiment, an ultrasonic probe is selected as a water immersion ultrasonic probe, and a nozzle is arranged around the ultrasonic probe for outputting a water flow filled in the area between the coupling part and the thin-walled part during the measurement procedure of the ultrasonic probe. As shown in FIG. 10, the nozzle 201 is roughly in a U-shaped structure, the bottom of its central position is provided with a water immersion ultrasonic probe 202, a water outlet is arranged around the water immersion ultrasonic probe 202, the couplant flows out from the water outlet and is filled on the U-shaped structure, an eddy current sensor 203 for distance measurement is also arranged on the outside of the nozzle 201, and the nozzle 201 is arranged at a certain interval with respect to the thin-walled part 204.

Further, the pressure of the water generated by the nozzle 201 is also used to support thin-walled part.

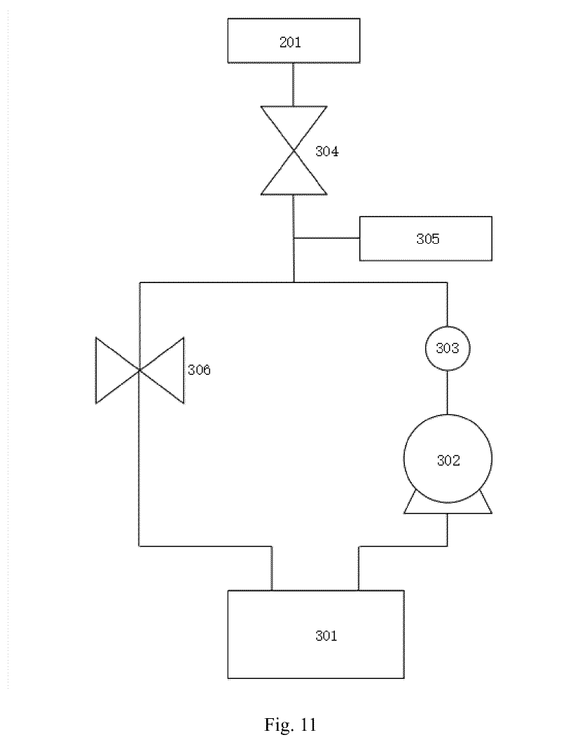

In addition, as shown in FIG. 11, the pre-stage of the nozzle comprises a series of water supply systems, including a water tank 301 as a water source, a water pump 302 providing water flow, a defoaming device 303 for defoaming the water flow output by the water pump 302, and a fluid valve 304 for outputting water flow to the nozzle 201.

In the thickness measurement procedure, the water pump 302 transmits and extracts the couplant from the water tank 301, and after it is output through the output port of the water pump 302, the air bubbles generated in the couplant due to the pressurization disturbance of the water pump 302 are removed through the defoaming device 303, and then the fluid valve 304 is opened, and the couplant is ejected through the nozzle. Due to the semi-closed structure of the nozzle 302 itself, the water flow will form a back pressure pointing to the nozzle 201 to a certain extent after touching the back of the thin-walled part, which is positively correlated with the pressure of the water of the thickness measurement.

During the measurement procedure, in order to maintain the consistency of the previous and subsequent measurement processes, it is necessary to control the pressure of the water of the thickness measurement to be kept constant. In this embodiment, a water pressure sensor 305 is introduced between the fluid valve 304 and the defoaming device 303, and the drainage back pressure is collected and a real-time water pressure value is output. For the nozzle 201, the standard value of water pressure is obtained through experimental calibration in advance, and the better thickness measurement effect is achieved by controlling the real-time water pressure value to be consistent with the standard value of water pressure.

The control procedure of real-time water pressure value can, based on PID algorithm, process the difference between the real-time water pressure value and the standard value of water pressure, and control the speed of water pump 302 to realize this process, and can also adopt the mode of bypass pressure relief to realize.

Specifically, in the front stage of the fluid valve 304, a three-point joint is arranged, which is connected to the water injection port of the water tank 301 through the electric ball valve 306, forming a return channel of the water pump 302, the electric ball valve 306, and the water tank 301. The degree of opening and closing of the electric ball valve 306 depends on the difference between the real-time water pressure value and the water pressure standard value. Specifically, when the water pressure difference value is positive, it indicates that the real-time water pressure value exceeds the standard value of water pressure, and the angle of the opening and closing of the electric ball valve 306 increases, and the real-time water pressure value is reduced; when the water pressure difference value is negative, it indicates that the real-time water pressure value is lower than the standard value of water pressure, and the angle of the opening and closing of the electric ball valve 306 decreases, and the real-time water pressure value is increased.

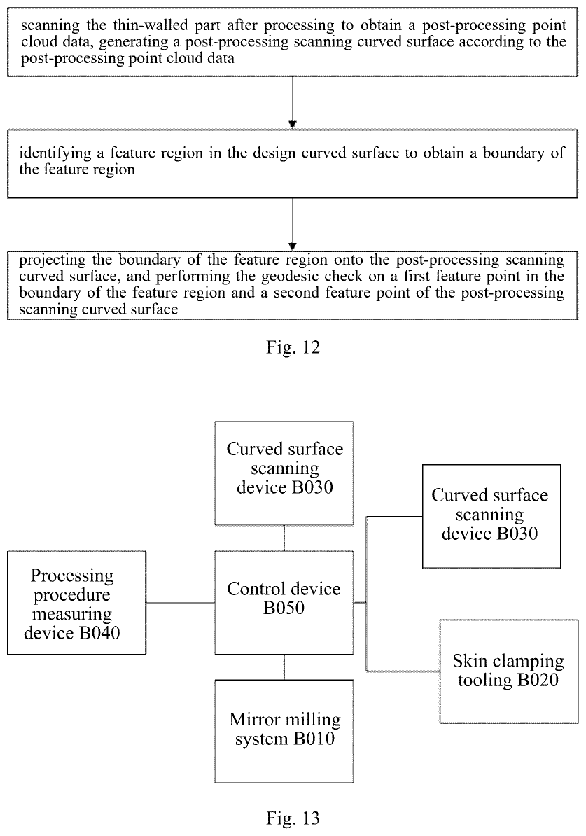

In an embodiment, as referred to FIG. 12, the thin-walled part processing contour detection procedure includes:
scanning the thin-walled part after processing to obtain a post-processing point cloud data, generating a post-processing scanning curved surface according to the post-processing point cloud data;
identifying a feature region in the design curved surface to obtain a boundary of the feature region;
projecting the boundary of the feature region onto the post-processing scanning curved surface, and performing the geodesic check on a first feature point in the boundary of the feature region and a second feature point of the post-processing scanning curved surface.

Specifically, in order to ensure that the thin-walled part after processing is consistent with the design curved surface, the processing contours of the thin-walled part is also detected after the thin-walled part processing and measurement and control of the thickness procedure is completed. Specifically, for design curved surfaces, feature areas that can be used for comparison and feature points in feature areas are pre-labeled. After the processing is completed, the same line laser is used to scan the thin-walled part after processing to obtain the post-processing point cloud data, and the post-processing scanning curved surface is reconstructed and obtained. Correspondingly, for the design curved surface, the feature boundary recognition algorithm is used to extract the pre-labeled feature area boundary. Since the design curved surface and the thin-walled part have been aligned in advance, the boundary of the feature area can be projected onto the post-processing scanning curved surface, and then the geodesic information is calculated on the feature points corresponding to the feature area on the post-processing scanning curved surface, and the geodesic information on the design curved surface is compared according to the geodesic information and the pre-labeled feature points, so as to judge whether the processing contours meets expectations.

A processing system used to implement processing method as described above.

As shown in FIG. 13, the processing system includes a clamping tooling B020, the clamping tooling B020 is used for clamping thin-walled part;
the clamping tooling B020 is provided with a jacking device B021, the jacking device B021 is used to move synchronously with the milling cutter during the mirror milling procedure, to jack the thin-walled part.

In order to realize the above mentioned processing method, in the embodiment there is also provided a corresponding processing system, and the processing system should at least comprise a mirror milling system B010, a clamping tooling B020, a curved surface scanning device B030, a processing procedure measuring device B040 and a control device B050. The clamping tooling B020 comprises a jacking device B021, the jacking device B021 is used for synchronous movement with the milling cutter in the mirror milling procedure, to support the thin-walled part, and the processing procedure measuring device B040 is used for providing real-time data of the processing to the control device B050 in the mirror milling procedure to realize closed-loop control. The control device B050 is used for controlling each of the above-mentioned modules according to a pre-configured computer program.

The above is only a better embodiment of the present invention, and does not limit the embodiment and scope of protection of the present invention, and those skilled in the art should realize that all schemes obtained by using the equivalent substitution and obvious changes made by the description and drawings of the present invention should be included in the scope of protection of the present invention.

What is claimed is:

1. A mirror milling processing and measurement process and control process method, comprising a thin-walled part clamping and transferring procedure, a thin-walled part measurement and point cloud acquisition procedure, a thin-walled part processing path program transplantation procedure, a thin-walled part processing path post-processing procedure, a thin-walled part processing and thickness measurement and control procedure, and a thin-walled part processing contour detection procedure;
wherein the thin-walled part processing path program transplantation procedure comprises:
aligning, according to an actual positioning hole in a point cloud data obtained by scanning the thin-walled part and a theoretical positioning hole on a theoretical triangle mesh curved surface generated by a design curved surface, an actual triangle mesh curved surface corresponding to the point cloud data with the theoretical triangle mesh curved surface;
calculating, for a plurality of cutter location points in a cutter location file, geodesic information between each of the cutter location points and the theoretical positioning hole respectively;
transplanting, according to the geodesic information, the cutter location points to the actual triangular mesh curved surface to form a transplantation processing path.

2. The mirror milling processing and measurement process and control process method of claim 1, wherein during the thin-walled part clamping and transferring procedure, a clamping tooling is arranged to clamp the thin-walled part, the clamping tooling comprises a tooling frame, the tooling frame is mouth-shaped, and a plurality of moving posts are distributed in the tooling frame;
a clamping jaw is installed on the tooling frame and the moving posts, and the clamping jaw clamps and fixes the thin-walled part;
a plurality of jacking devices are further distributed in the tooling frame, and the plurality of jacking devices move from a back of the thin-walled part to a front of the thin-walled part so as to support the thin-walled part.

3. The mirror milling processing and measurement process and control process method of claim 2, wherein the thin-walled part clamping and transferring procedure comprises:
hoisting the thin-walled part to the tooling frame, and projecting a laser projection to the tooling frame;
locating the thin-walled part in a coverage area of the laser projection;
adjusting, according to the laser projection and a tooling program, the jacking devices and the clamping jaw so as to adjust the thin-walled part to a predetermined processing state;
clamping the thin-walled parts successively, and scanning the thin-walled parts to obtain the point cloud data.

4. The mirror milling processing and measurement process and control process method of claim 1, wherein during the thin-walled part measurement and point cloud acquisition procedure, a machine tool drives a line laser to scan the thin-walled part to construct the point cloud data.

5. The mirror milling processing and measurement process and control process method of claim 1, the cutter location point extraction procedure for calculating the cutter location file comprises:
extracting the theoretical positioning hole center coordinates of the theoretical positioning holes on the theoretical triangular mesh curved surface respectively, and extracting the cutter location point information of each of the cutter location points from the cutter location file respectively, wherein the cutter location point information comprises a cutter location point coordinate;
projecting, for each of the cutter location points, the cutter location point onto a theoretical mesh surface of the theoretical triangle mesh curved surface respectively, so as to generate a first projection point and a projection length between the first projection point and the cutter location point coordinate;
calculating the area coordinates of the first projection point with respect to a mesh to which the first projection point is located respectively, and calculating, for each of the theoretical positioning hole center coordinates, a length of the geodesic with respect to the area coordinates respectively to function as the geodesic information.

6. The mirror milling processing and measurement process and control process method of claim 1, wherein the path transplantation procedure for forming the transplantation processing path comprises:
extracting the actual positioning hole center coordinates of the actual positioning holes from the point cloud data respectively, and projecting the cutter location point onto a second projection point obtained from an actual mesh surface corresponding to the point cloud data;
calculating, for the second projection point, a length of the pre-projected geodesic with respect to the actual positioning hole center coordinates, and processing, according to the geodesic information, the length of the pre-projected geodesic to obtain a geodesic deviation value;
iterating, according to the geodesic deviation value and the preset geodesic deviation range, the second projection point until the geodesic deviation range is satisfied and the second projection point functions as an actual transplantation point;
generating, according to the actual transplantation point, the transplantation processing path.

7. The mirror milling processing and measurement process and control process method of claim 1, wherein the thin-walled part processing path post-processing procedure comprises, generating a new transplanted cutter location file according to the transplantation processing path, and performing a simulation verification on the transplanted cutter location file;
during the thin-walled part processing and measurement and control of the thickness procedure, processing the thin-walled part by the transplanted cutter location file.

8. The mirror milling processing and measurement process and control process method of claim 2, wherein during the thin-walled part processing and measurement and control of the thickness procedure, jacking a subsidence area of the thin-walled part by the jacking device.

9. The mirror milling processing and measurement process and control process method of claim 1, wherein during the thin-walled part processing and measurement and control of the thickness procedure, measuring the thickness of the thin-walled part in real time by an ultrasonic probe to obtain the real-time thickness of the thin-walled part, and the real-time thickness is used for controlling during the mirror milling procedure of the thin-walled part.

10. The mirror milling processing and measurement process and control process method of claim 9, wherein the ultrasonic probe is distributed along a circumferential direction with a plurality of eddy current sensors, and during the measurement procedure of the ultrasonic probe the plurality of eddy current sensor sensors are used for generating an eddy current to measure the eddy current spacing between the ultrasonic probe and the thin-walled part;
during the mirror milling procedure, controlling a distance between the ultrasonic probe and the thin-walled part based on the eddy current spacing.

11. The mirror milling processing and measurement process and control process method of claim 10, wherein during the measurement procedure of the ultrasonic probe, controlling the ultrasonic probe to direct to the back normal direction of the thin-walled part through the eddy current normal holding procedure;
the eddy current normal holding procedure comprises:
obtaining a back distance between a plurality of eddy current sensors and the thin-walled part;
constructing a machine tool coordinate system according to an eddy current distribution generated by the eddy current sensor, and transplanting the back distance in the machine tool coordinate system respectively;
coinciding a distribution center of the eddy current distribution with an origin of the machine tool coordinate system;
calculating a normal vector of the eddy current in the machine tool coordinate system according to the back distance obtained by transplantation;
adjusting the orientation of the ultrasonic probe based on the normal vector of the eddy current so that the normal vector of the eddy current coincides with a normal vector of the back of the thin-walled part.

12. The mirror milling processing and measurement process and control process method of claim 9, wherein the ultrasonic probe is a water immersion ultrasonic probe, an outside of a coupling part of the ultrasonic probe is provided with a nozzle, the nozzle is used to output a water flow filling an area between the coupling part and the thin-walled part during the measurement procedure of the ultrasonic probe;
a front stage of the nozzle is provided with a water pressure sensor and a real-time water pressure value is collected, during the mirror milling procedure, the pressure of the water flow is adjusted by comparing the real-time water pressure value with a standard water pressure value, and the thin-walled part is supported by the pressure of the water.

13. The mirror milling processing and measurement process and control process method of claim 1, wherein the thin-walled part processing contour detection procedure includes:
scanning the thin-walled part after processing to obtain a post-processing point cloud data, generating a post-processing scanning curved surface according to the post-processing point cloud data;
identifying a feature region in the design curved surface to obtain a boundary of the feature region;
projecting the boundary of the feature region onto the post-processing scanning curved surface, and performing the geodesic check on a first feature point in the boundary of the feature region and a second feature point of the post-processing scanning curved surface.

14. A processing system used to implement the mirror milling processing and measurement process and control process method of claim 1.

15. The processing system of claim 14, wherein the processing system includes a clamping tooling for clamping thin-walled part;
the clamping tooling is provided with a jacking device, the jacking device is used to move synchronously with the milling cutter during the mirror milling procedure, to jack up the thin-walled part.

16. The processing system of claim 15, wherein an ultrasonic probe is arranged on the top of the jacking device, the ultrasonic probe is used for measuring a thickness from the back of the thin-walled part during the mirror milling procedure.

17. The processing system of claim 14, the processing system includes an ultrasonic probe, the ultrasonic probe is used for measuring a thickness for the thin-walled part during the mirror milling procedure.

18. The processing system of claim 17, wherein the ultrasonic probe is provided with an eddy current sensor in a circumferential direction, and the processing system, according to the eddy current sensor, controls the ultrasonic probe to maintain a constant normal direction and spacing with respect to the thin-walled part.

19. The processing system of claim 17, wherein an outside of a coupling part of the ultrasonic probe is provided with a nozzle, the nozzle is used to output a water flow filling an area between the coupling part and the thin-walled part during the measurement procedure of the ultrasonic probe;
a front stage of the nozzle is provided with a water pressure sensor and a real-time water pressure value is collected, during the mirror milling procedure, the pressure of the water flow is adjusted by comparing the real-time water pressure value with a standard water pressure value.
